(19) United States
(12) Patent Application Publication
(10) Pub. No.: US 2005/0120298 A1
(43) Pub. Date: Jun. 2, 2005

(54) Content assembly for business process applications

(76) Inventor: Senja Jasenka Petrujkic, Delray Beach, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 10/726,191

(22) Filed: Dec. 2, 2003

(51) Int. Cl. G06F 15/00

(52) U.S. Cl. 715/511

(57) ABSTRACT

A method, system and apparatus for document content assembly and management. The system can include a document management system coupled to a workflow engine. A repository can be configured to store document fragments processed by different authoring roles managed through the workflow engine. Finally, a content assembler can be coupled to the repository and programmed to produce a composite document from the document fragments.

### BACKGROUND OF THE INVENTION

1. Statement of the Technical Field

The present invention relates to the field of document management systems and more particularly to document content assembly and management.

2. Description of the Related Art

Document management relates to the management and version control of documents produced and managed by one or more parties performing roles within the production and management process. Prior to the widespread adoption of personal computers in the business process, originally produced collaborative documents represented the end product of multiple draft documents produced by different actors in the course of the business process. Once created, the master document could be reproduced photostatically for the benefit of one or more actors in the business process charged with managing one or more portions of the master document.

In this regard, in the collaborative environment, typically more than one actor can produce textual content for a document. The combination of work product from a set of actors can result in the complete draft document. Similarly, multiple actors can remain focused on but a portion of a document once the document has been completed. In particular, while only a portion of a document may relate to the specific role fulfilled by one actor, a completely different portion of the document may relate to the specific role fulfilled by another actor. Hence, in the context of contract management, one actor may have assumed the role of enforcing payment terms of a contract, while another actor may have assumed the role of abiding by shipping terms of the same contract.

The widespread use of computer communications technologies in the workplace has produced substantial opportunities to automate the collaborative process of producing and managing documents within a business process. For instance, document management systems have become a central computing application prevalent throughout a multiplicity of vertical markets, including the corporate management market, the legal service market, and the financial services market. In the prototypical document management system, the creation, modification and deletion of documents can be controlled, audited and secured, usually based upon the role played by any one actor in the computing environment.

Document management systems alone, however, provide only a small aspect of document control in the business process. Specifically, while document management systems can provide a foundation for tracking the existence of a document and for limiting access thereto, document management systems in of themselves, do not contribute much to the collaborative process of creating, modifying or managing a document. To that end, separate versioning control systems have been developed independently from the document management market to assist in the lifecycle of a collaborative document.

Initially intended for use in the software development vertical market, version control systems track the state of a document as it passes through edit cycles. For nearly twenty years, version control systems have included the ability to highlight textual differences from document version to version so that one actor participating in the collaborative construction of a document can observe the changes to the document produced by another actor participating in the collaborative construction. So integral to collaborative editing process has visual “diffing” become, that this same decades old technology has become the cornerstone feature of many cutting edge word processing applications.

Regardless of the type of document management system, presently, managed documents do not contain information relating to the context or history of the transaction to which the document refers. For example, a document reflecting a contract between two or more parties in of itself will not indicate the state of the contracting process. Specifically, the contract alone cannot specify whether the contract merely has been proposed, is pending acceptance by management, is subject to an enforcement action, or is under review pending renewal. Consequently, different participants in the contracting process can manage copies of the contract under study differently.

Yet, changes to different portions of the document by different actors fulfilling different roles in an associated business process, all performed concurrently, can produce chaos in the process. Where one actor can manage one portion of a document with a first aim in mind, one or more other actors can manage other portions of the document with different aims in mind and without concern for the aims of the other actors. Consequently, individual efforts can be lost as unnecessary resources can be consumed attempting to harmonize the different management aims in respect to a single document.

Importantly, depending upon the nature of a collaborative document, different portions of the document, or the document in its entirety can be managed in the course of multiple business processes. So much will be evident to the skilled artisan when considering the exemplary circumstance of contract management. In the context of contract management, certain document clauses can appear in multiple contracts, for instance a standard waiver of warranty or a standard forum and venue clause. Similarly, where multiple jurisdictions may be involved, an identical contract may have minor portions which vary by jurisdiction. Such portions typically can be building-block sections to the contract which can be combined in an automated manner to construct a contract without requiring the manual formulation of the contract.

The same circumstance can be observed in the insurance industry where insurance policy documents are constructed based upon the end-user selection of different clauses for inclusion in the insurance policy based upon the particular selected coverage terms and the applicable jurisdiction. Due to the monolithic nature of documents, however, these document assembly systems provide no ability to track boiler plate building blocks once incorporated into respective documents. That is to say, once the document has been constructed using a specific set of building block sections, changes to the underlying building blocks are not reflected in the already produced composite document.

Importantly, while great strides have been taken in the construction of documents for use even in the most complex of business processes, little effort has been expended in producing systems for managing documents throughout the document lifecycle. Even with the most sophisticated document management system in existence today, none provide an inherent ability to query the context of a document exclusive of the keyword searching. Yet, within the enterprise environment, it would be helpful to identify documents having a textual portions which reflect the management decisions of a particular actor fulfilling a role in the business process in the course of which the textual portion at issue had been modified or crafted to achieve a specific objective. Moreover, it would further be helpful to programmatically review a collection of documents to locate and interpret specific portions of the document in a contextual manner.

Today, to undertake the identification of documents having textual portions which reflect management decisions of a particular actor require the prolonged manual review of paper documents. To the extent that the identification process can be performed through the execution of one or more strategically formulated keyword queries, the manual composition of the queries and an appropriate selection of keywords still will be required to produce a set relevant documents. The set would then be further processed to eliminate drafts, inactive documents or those which are not relevant. Current document repositories do not provide means to segregate business and legal terms or provide a view into document sections appropriate for specific persons' role in the business.

### SUMMARY OF THE INVENTION

The present invention addresses the deficiencies of the art in respect to document content assembly and management and provides a novel and non-obvious method, system and apparatus for document content assembly and management. A system for document content assembly and management can include a document management system coupled to a workflow engine. A repository can be configured to store document fragments processed by different authoring roles managed through the workflow engine. Finally, a content assembler can be coupled to the repository and programmed to produce a composite document from the document fragments.

In a preferred aspect of the invention, a second repository can be coupled to the workflow engine and configured to store activities defining at least one business process. Similarly, a second repository can be coupled to the document management system and configured to store document templates. Each of the document templates can reference selected ones of the document fragments to produce a single composite document. Finally, a digest of textual elements can be coupled to the content assembler. Each of the textual elements can denote individual ones of the fragments in respective documents.

A document content assembly and management method can include the steps of defining a business process having one or more activities and one or more authoring roles authorized to participate in the activities. Modifications can be applied to selected document fragments through the authoring roles. The document fragments can be combined to form a single composite document. Finally, the document can be rendered for viewing by at least one of the authoring roles. In a preferred aspect of the invention, the method can include the step of storing state information with the document fragments to indicate a state within the business process for a particular version of the document fragments. In this regard, the combining step can include the step of combining individual ones of the document fragments having state information indicating a specified state within the business process.

A document content assembly and management method can include defining a business process having multiple activities and multiple actors performing the activities. A document can be composed from a set of document fragments. Importantly, different ones of the document fragments can be assigned to different ones of the multiple actors for processing within different activities in the business process. Finally, a view to the composed document can be provided which can reflect real-time modifications to the document fragments by the multiple actors. Moreover, a processing history can be indicated for the document fragments in the view.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of an integrated document content assembly, management and workflow system;

FIG. 2 is a pictorial illustration of the integration of multiple roles, multiple activities within one or more business processes, multiple content fragments and multiple documents formed with the fragments in the system of FIG. 1; and,

FIGS. 3A and 3B, taken together, are a flow chart illustrating a process for managing a document decomposed into its respective fragments in the system of FIG. 1.

### DETAILED DESCRIPTION OF THE PREFERRED EMBODIMENTS

The present invention is a document content management and assembly system, method and apparatus. In accordance with the present invention, a single compound document can be partitioned into a set of content fragments which can vary from authoring role to authoring role in one or more different business processes. Each fragment can be assigned to at least one authoring role. Each authoring role can apply modifications to one or more respectively assigned fragments. As the modifications are applied, the modified fragments can be reflected within a view of the single compound document. In this regard, the fragments can be modified, regardless of the particular business process within which the fragments are modified. Yet, a current view of the single compound document can be provided on demand which can reflect the most recent modifications to the fragments of the document.

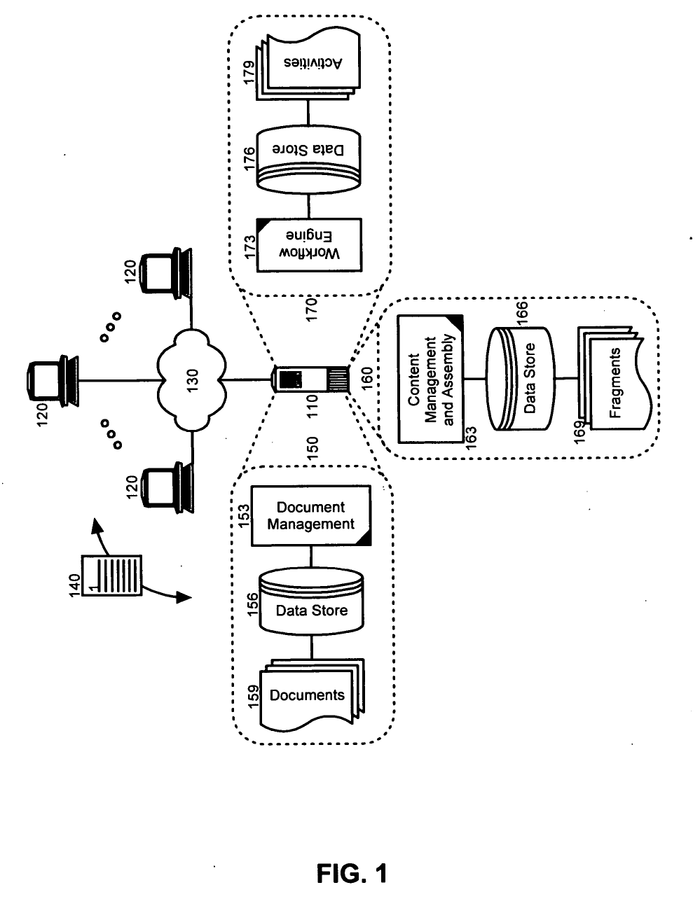

In further illustration, FIG. 1 is schematic illustration of an integrated document content assembly, management and workflow system. The system can include an integrated document content assembly, management and workflow system 110 coupled to one or more client computing stations 120 associated with one or more respective authoring roles (not shown). As it is to be understood by the skilled artisan, an authoring role as described herein can include a person or group of persons charged with creating, modifying or reviewing a variable portion or section of a document in the course of addressing an established goal within a business process. As an example, an authoring role within a sales and marketing business process can include the production of a report section describing sales data for a particular product within a particular sales territory.

The system 110 can include a document management component 150, a content management and assembly component 160 and a workflow component 170. The document management component 150 can perform conventional document management functions such as storing documents and controlling access thereto. The document management component 150 also can maintain an audit trail for each managed document. The content management and assembly component 160, by comparison, can manage variable and static portions of documents. In particular, individual compound documents can be decomposed into their constituent variable and static parts. Conversely, individual compound documents can be formed through the combination of variable and static parts. In both cases, static parts remain static and cannot be modified by any one role in a meaningful way. The variable parts, by comparison, can be modified by one or more roles in the course of a business process.

Finally, the workflow component 170 can support the processing of documents throughout a defined business process. The business process can include one or more activities in which different authoring roles can participate. As an example, a mortgage business process can include a sales and marketing activity, an application activity, an underwriting activity, a closing activity and a loan servicing activity. Different authoring roles can be assigned these activities, including direct sales, customer service, mortgage underwriting and loan processing. Even a legal support role can be assigned to the underwriting and closing activities to control the formation of loan documents associated with these business processes. The workflow component 170 can ensure that the appropriate authoring roles receive access to their respective assigned portions of the relevant documents at the appropriate time within the business process.

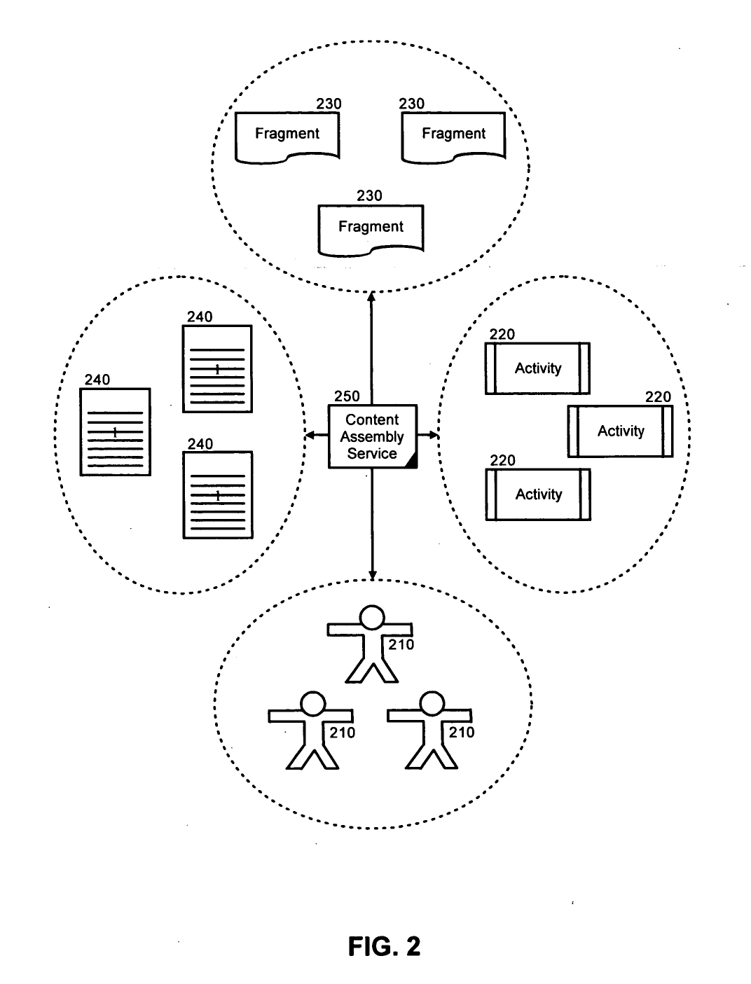

In accordance with the present invention, each of the different components 150, 160, 170 of the system 110 can interact with one another to produce a multi-role, multi-document, multi-business process document content assembly and management system. To better illustrate the interrelationship between the different components 150, 160, 170 of the system 110, FIG. 2 illustrates the integration of multiple roles 210, multiple activities 220 within one or more business processes, multiple content fragments 230 and multiple documents 240 formed with the fragments 230. Specifically, different authoring roles 210 can be assigned to one or more of the different activities 220 associated with a particular business process. Each activity 220 further can be associated with one or more fragments 230. In this regard, the fragments 230 of an activity 220 can be integral to the performance of the activity 220, regardless of whether the fragments 230 are to be modified in the course of the activity 220, or merely reviewed in the course of the activity 220.

The fragments 230 individually can represent a variable portion of a single compound one of the documents 240. In this regard, each of the fragments 230 can relate to a specific aspect of a related one of the documents 240, and can include by way of example, individual legal clauses in a contract, the lifecycle control of a transaction, the parties to an agreement, the business terms of documented relationship, the phases of a construction project, the specification of a modular portion of a computer program, and the like. The fragments 230 further can be incorporated within multiple documents 240 and, as such, can be accessed by different authoring roles 210 through different activities 220 associated with different business processes.

Consequently, a mere templated specification of a document by way of reference to one or more fragments 230 can result in the compound construction of one or more of the documents 240. Conversely, any one of the documents 240 can be decomposed into its constituent fragments 230 for modification and review by assigned ones of the roles 210 in the course of one or more corresponding activities 220. In all cases, however, the content assembly service 250 of the present invention can coordinate the foregoing integration and interrelationship of the authoring roles 210, the activities 220, the fragments 230, and the documents 240.

Returning now to FIG. 1, in operation a set of activities 179 can be defined within the workflow component 170 and stored in data store 176. The activities 179 in combination can represent a business process in which one or more documents 159 stored in the data store 156 can be created, modified or otherwise accessed by clients 120 assigned to the different activities 179. A workflow engine 173 can manage the business process defined by the activities 179 including the sequential processing of documents 159 in the course of one or more activities. Importantly, one or more authoring roles can be associated with the activities 179 and the authoring roles can include both individuals and groups of individuals.

Rather than modifying the documents 159 per se, fragments 169 stored in the data store 166 which in concert form the core of the documents 159 can be created, modified or otherwise accessed within the activities 179. In this regard, the fragments 169 can be stored in the data store 166 and managed through the content management and assembly process 163. The content management and assembly process 163 both can deconstruct documents 159 into their constituent fragments and static components, and also the content management and assembly process 163 can produce one or more of the documents 159 by combining individual ones of the fragments 169. To that end, the documents 159 can include one or more templates referencing the fragments 169 such that as the fragments 169 change, so too will the corresponding documents 159 incorporating the fragments 169. Accordingly, a document management process 153 can manage the structuring of the documents 159 in addition to providing more traditional document management functions.

Significantly, as a document such as the document 140 can be defined not as a single, monolithic document, but as a strategic collection of constituent fragments 169, the document 140 can be accessed, modified, created or otherwise processed by multiple clients 120 concurrently. Each one of the clients 120 can view the present state of the document 140 including all changes to the underlying fragments 169 reflected therein. Notwithstanding, where fragments 169 can incorporate state information such as the state of a transaction as it relates to a specific version of the fragments 169, the document 140 can selectably represent the version of the document which does not incorporate the most recent collection of fragments 169, but a collection of fragments 169 which had existed previously at a prior state in the business process.

It will be recognized by the skilled artisan that the inventive arrangement of the content assembly system of the present invention can afford substantial advantages not attainable by way of the prior art. Specifically, while in the prior art a document could be managed and processed in its entirety in a sequential manner through red-lining techniques, in the present invention, a document is not managed by multiple collaborating authoring roles. Rather, the multiple collaborating authoring roles individually can process fragments of a common, single composite document such that the view of the composite document always can represent the entirety of the collaboration even where the collaboration occurs concurrently among the different authoring roles.

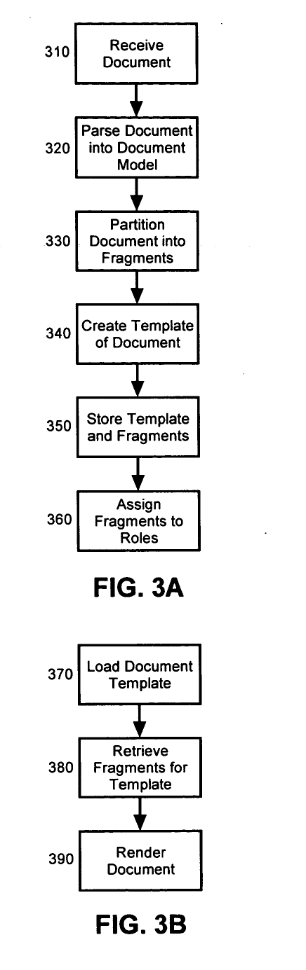

In further illustration of the core principle of the present invention, FIGS. 3A and 3B, taken together, are a flow chart illustrating a process for managing a document decomposed into its respective fragments in the system of FIG. 1. Beginning first in block 310 of FIG. 3A, a document can be received in the content assembly and management system for processing. In block 320, the document can be parsed into a document model in which the structure of the document can be modeled while the variable and static portions of the document can be identified. In particular, a set of known textual indicators or tags can be used to identify variable aspects of the document. Moreover, structural features of the documents can account for variable and static aspects of the document.

In any case, in block 330, the document can be partitioned into fragments based upon the document model. Subsequently, in block 340 a document template can be created for the document. The document template can indicate which fragments are to be combined to form the document along with static elements. In block 350, the template and the fragments can be persisted in fixed storage for subsequent retrieval. Finally, in block 360 individual authoring roles can be assigned to access, modify or otherwise process the fragments. In particular, the individual authoring roles can be directly assigned to the fragments, or indirectly assigned to the fragments through the operation of one or more assigned activities within a business process.

Turning now to FIG. 3B, in block 370, the document template can be loaded at a subsequent time to view the document. Once loaded, the document template can indicate which fragments to load to provide a view of the document which reflects a particular state within the business process. In block 380 the selected fragments can be retrieved and in block 390 the document can be rendered accordingly. Optionally, the view of the document as rendered can be limited to only those fragments to which the authoring role has been permitted access. Significantly, the document as constructed will reflect the collaborative efforts of the authoring roles at a particular state within a business process. Where the state simply reflects the most recent state of the business process, the document will reflect the most current rendition of the document.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A content assembly and management system comprising:
a document management system coupled to a workflow engine;
a repository configured to store document fragments processed by different authoring roles managed through said workflow engine; and,
a content assembler coupled to said repository and programmed to produce a composite document from said document fragments.

2. The system of claim 1, further comprising a second repository coupled to said workflow engine and configured to store activities defining at least one business process.

3. The system of claim 1, further comprising a second repository coupled to said document management system and configured to store document templates each of said document templates referencing selected ones of said document fragments to produce a single composite document.

4. The system of claim 1, further comprising a digest of textual elements coupled to said content assembler, each of said textual elements denoting individual ones of said fragments in respective documents.

5. A document content assembly and management method, the method comprising the steps of:
defining a business process having a plurality of activities and a plurality of authoring roles authorized to participate in said activities;
applying modifications to selected document fragments through said authoring roles; and,
combining said document fragments to form a single composite document; and,
rendering said document for viewing by at least one of said authoring roles.

6. The method of claim 5, further comprising the step of storing state information with said document fragments to indicate a state within said business process for a particular version of said document fragments.

7. The method of claim 6, wherein the combining step comprises the step of combining individual ones of said document fragments having state information indicating a specified state within said business process.

8. A document content assembly and management method, the method comprising the steps of:
defining a business process having multiple activities and multiple actors performing said activities;
composing a document from a set of document fragments;
assigning different ones of said document fragments to different ones of said multiple actors for processing within different activities in said business process; and,
providing a view to said composed document reflecting real-time modifications to said document fragments by said multiple actors.

9. The method of claim 8, further comprising the step of indicating a processing history for said document fragments in said view.

10. A machine readable storage having stored thereon a computer program for document content assembly and management, the computer program comprising a routine set of instructions which when executed by the machine cause the machine to perform the steps of:
defining a business process having a plurality of activities and a plurality of authoring roles authorized to participate in said activities;
applying modifications to selected document fragments through said authoring roles; and,
combining said document fragments to form a single composite document; and,
rendering said document for viewing by at least one of said authoring roles.

11. The machine readable storage of claim 10, further comprising the step of storing state information with said document fragments to indicate a state within said business process for a particular version of said document fragments.

12. The machine readable storage of claim 11, wherein the combining step comprises the step of combining individual ones of said document fragments having state information indicating a specified state within said business process.

13. A machine readable storage having stored thereon a computer program for document content assembly and management, the computer program comprising a routine set of instructions which when executed by the machine cause the machine to perform the steps of:
defining a business process having multiple activities and multiple actors performing said activities;
composing a document from a set of document fragments;
assigning different ones of said document fragments to different ones of said multiple actors for processing within different activities in said business process; and,
providing a view to said composed document reflecting real-time modifications to said document fragments by said multiple actors.

14. The machine readable storage of claim 13, further comprising the step of indicating a processing history for said document fragments in said view.
